(19) United States
(12) Patent Application Publication
(10) Pub. No.: US 2026/0356761 A1
(43) Pub. Date: Nov. 12, 2026

(54) COMPOSITE CERAMIC

(71) Applicant: KYOCERA Corporation, Kyoto-shi, Kyoto (JP)

(72) Inventors: Shojiro HAYATA, Kirishima-shi, Kagoshima (JP); Minako IZUMI, Kirishima-shi, Kagoshima (JP); Toshifumi HIGASHI, Kirishima-shi, Kagoshima (JP)

(73) Assignee: KYOCERA Corporation, Kyoto-shi, Kyoto (JP)

(21) Appl. No.: 19/113,483

(22) PCT Filed: Sep. 29, 2023
(86) PCT No.: PCT/JP2023/035661

§ 371 Date: Mar. 20, 2025

(30) Foreign Application Priority Data
Sep. 29, 2022 (JP) 2022-156868

(51) Int. Cl. C04B 35/119

(52) U.S. Cl. CPC C04B 35/119; C04B 2235/3217; C04B 2235/3246; C04B 2235/3418; C04B 2235/528

(57) ABSTRACT

A composite ceramic includes a plurality of alumina particles, a plurality of zirconia particles, and a Si composite oxide phase. The plurality of alumina particles includes a prismatic particle. The plurality of zirconia particles includes a spherical particle. The prismatic particle includes prismatic particles, and the spherical particle includes spherical particles, the prismatic particles and the spherical particles having first contact parts in each of which a surface of the prismatic particle and a surface of the spherical particle are partially in contact with each other.

### TECHNICAL FIELD

An embodiment of the present disclosure relates to a composite ceramic.

### BACKGROUND OF INVENTION

A known composite ceramic contains a plurality of ceramic particles having different main components. For example, the present applicant has proposed a sintered body containing alumina particles and zirconia particles as a composite ceramic having high strength and toughness (see Patent Document 1).

### CITATION LIST

### Patent Literature

Patent Document 1: WO 2006/080473

### SUMMARY

A composite ceramic according to an aspect of an embodiment includes a plurality of alumina particles, a plurality of zirconia particles, and a Si composite oxide phase. The plurality of alumina particles includes a prismatic particle. The plurality of zirconia particles includes a spherical particle. The prismatic particle includes prismatic particles, and the spherical particle includes spherical particles, the prismatic particles and the spherical particles having first contact parts in each of which a surface of the prismatic particle and a surface of the spherical particle are partially in contact with each other.

### BRIEF DESCRIPTION OF THE DRAWINGS

FIG. 1 is a cross-sectional view illustrating an example of a composite ceramic according to an embodiment.

FIG. 2 is a graph showing a relationship between aspect ratio and frequency of alumina particles contained in a composite ceramic.

### DESCRIPTION OF EMBODIMENTS

The composite ceramic described above had, for example, poor deformability and had room for improvement.

Expectations of a composite ceramic having high deformability exist.

Hereinafter, embodiments of a composite ceramic disclosed in the present application will be described with reference to the accompanying drawings. Note that the present disclosure is not limited to the embodiments described below.

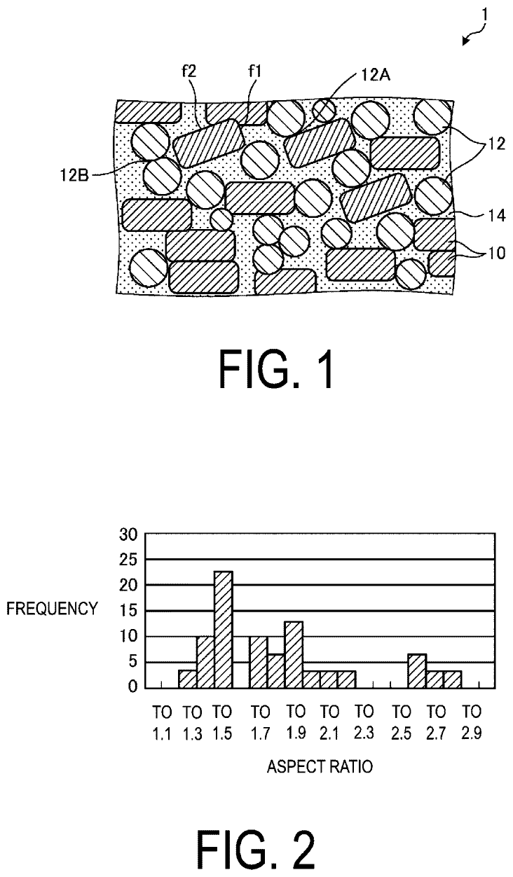

FIG. 1 is a cross-sectional view illustrating an example of a composite ceramic according to an embodiment. As illustrated in FIG. 1, the composite ceramic 1 according to the embodiment includes a plurality of alumina particles 10, a plurality of zirconia particles 12, and a Si composite oxide phase 14.

The composite ceramic 1 includes prismatic particles in the plurality of alumina particles 10. The prismatic particles are particles containing alumina as a main component. Hereinafter, the prismatic particles may be referred to as prismatic alumina particles 10.

The composite ceramic 1 includes the prismatic alumina particle 10 and the spherical zirconia particle 12 having a contact part in which a surface of the prismatic alumina particle 10 and a surface of the spherical zirconia particle 12 are partially in contact with each other. Note that the contact part may be referred to as a first contact part 12A.

Note that the contact part refers to a part in which a part of a surface of the prismatic alumina particle 10 is in contact with a part of the spherical zirconia particle 12. “In contact” in this case is regardless of the bonding strength between the part of the alumina particle 10 and the part of the zirconia particle 12. For example, the meaning of “in contact” includes from a condition in which the part of the alumina particle 10 and the part of the zirconia particle 12 can slip out of place even by a low load to a condition in which the part of the alumina particle 10 and the part of the zirconia particle 12 are sintered and are less likely to slip out of place. In these cases, the Si composite oxide phase 14 is preferably present around the part of the alumina particle 10 and the part of the zirconia particle 12.

Examples of the Si composite oxide phase 14 include aluminum silicate and zircon in addition to glass, whose representative examples include borosilicate glass. The Si composite oxide phase 14 preferably contains at least one selected from the group consisting of borosilicate glass, aluminum silicate, and zircon. Hereinafter, the Si composite oxide phase 14 may be referred to as a composite oxide phase 14.

The configuration described above can provide a ceramic that is readily deformed. In other words, a composite ceramic 1 that is flexible can be obtained.

Note that the composite ceramic 1 that is readily deformed or flexible means that the composite ceramic 1 exhibits a great deformability when the composite ceramic 1 is deformed from the initial shape. The deformability refers to an amount of load-point displacement determined by, for example, three-point bending test performed for a test piece of a composite ceramic 1. This amount of displacement refers to an amount of deformation in a range where the test piece of the composite ceramic 1 undergoes an elastic deformation. The deformability of the composite ceramic 1 refers to a maximum value of the amount of deformation in a range where the test piece does not break; however, herein, the deformability refers to an amount of displacement at breakage of a test piece when the three-point bending test is performed for the test piece, for convenience, because the three-point bending test is performed simultaneously as described below.

The composite ceramic 1 has properties that facilitate deformation due to the composite ceramic 1 containing the zirconia particles 12, which readily undergo an elastic deformation, together with the alumina particles 10 although the alumina particles themselves are less likely to bend. The composite ceramic 1 containing the Si composite oxide phase 14 is also a reason why the composite ceramic 1 readily deforms.

The composite ceramic 1 contains the Si composite oxide phase 14 in a region other than the region of the alumina particles 10 and the zirconia particles 12. In other words, the Si composite oxide phase 14 is present around the alumina particles 10 and the zirconia particles 12.

Since the Si composite oxide phase 14 is present adjacent to the alumina particles 10 and the zirconia particles 12, the binding forces between the alumina particles 10, between the zirconia particles 12, and between the alumina particle 10 and the zirconia particle 12 decrease due to the Si composite oxide phase 14 in the composite ceramic 1.

The composite ceramic 1 has properties that facilitate deformation also due to the combination of the two types of the particles, which are the prismatic alumina particles 10 and the spherical zirconia particles 12 contained in the composite ceramic 1.

The composite ceramic 1 includes a crystal structure including spherical zirconia particle 12 in contact with a surface of the prismatic alumina particle 10. In this case, because the zirconia particle 12 is spherical, a part of the surface of the spherical zirconia particle 12 is in contact with a surface of the prismatic alumina particle 10. In other words, the prismatic alumina particle 10 and the spherical zirconia particle 12 are in contact in a small area.

In the composite ceramic 1, the binding force between the prismatic alumina particle 10 and the spherical zirconia particle 12 is thought to be small, and the prismatic alumina particle 10 and the spherical zirconia particle 12 are thought to easily move because the prismatic alumina particle 10 and the spherical zirconia particle 12 are in contact in a small area. Since the prismatic alumina particle 10 and the spherical zirconia particle 12 are in contact in a small area in this manner, the binding force between both of the particles becomes small. In this case, the proportion of the contact of the zirconia particle 12 to the surface of the alumina particle 10 is preferably in a range described below.

For example, when a length (length that is a side in a photograph) of a surface to which a zirconia particle 12 is in contact is L1 and a length (length that is a side in a cross-sectional view) of a contact face between the alumina particle 10 and the zirconia particle 12 is L2 among surfaces of the alumina particle 10 upon observation of a cross section of the composite ceramic 1, the ratio thereof (L2/L1) is preferably not less than 1% and not more than 10%. By this, excessive binding between the alumina particle 10 and the zirconia particle 12 is less likely to occur. In this case, a plurality of zirconia particles 12 may be in contact with one surface (side) of one alumina particle 10.

When the zirconia particle 12 can be seen as being in contact with the alumina particle 10, the Si composite oxide phase 14 may be interposed thinly between the alumina particle 10 and the zirconia particle 12. The thickness of the Si composite oxide phase 14 in this case is preferably not less than 0 μm and not more than 1 μm, and particularly preferably not more than 0.5 μm.

Contrary, when both of alumina particles 10 and zirconia particles 12 are in prismatic forms and a large number of parts in which the alumina particle 10 and the zirconia particle 12 are in contact at their side faces exist, the binding force therebetween is stronger due to the larger contact area between the alumina particle 10 and the zirconia particle 12.

The reasons why this composite ceramic 1 tends to have properties facilitating deformation include that: the crystal structure includes the zirconia particles 12; the prismatic alumina particles 10 and the spherical zirconia particles 12 are contained; and a surface of the spherical zirconia particle 12 is partially in contact with a surface of the prismatic alumina particle 10.

Note that a range of the contact of the spherical zirconia particle 12 with the prismatic alumina particle 10 is not less than 1 and not more than 20 and may be not less than 1 and not more than 10 when the length of the contour of the spherical zirconia particle 12 is 100.

The composite ceramic 1 is preferably a closely packed body. Note that the “closely packed body” indicates the porosity of not more than 5%. The porosity of the composite ceramic 1 can be calculated based on the result of observation of a cross section of the composite ceramic 1 using a scanning electron microscope (SEM).

For measurement of the porosity of the composite ceramic 1, for example, first, a designated area of a cross section of the composite ceramic 1 is decided, and a total area of pores present in the designated area is determined. Then, a method of determining the porosity by dividing the total area of the pores by the designated area of the cross section is preferably used.

Again, the plurality of alumina particles 10 includes the prismatic particles. Note that the “prismatic” means a case in which a cross section of the composite ceramic 1 is in an oblong polygon shape when the cross section of the composite ceramic 1 is observed by using an SEM. The polygon shape refers to a shape having at least two long sides and two short sides in the contour thereof when the cross section of the alumina particle 10 is observed. In this case, the two long sides and the two short sides are each arranged facing each other. The two long sides are not necessarily in parallel. The two short sides are also not necessarily in parallel. A part of a long side may be bent at a small angle, and this part may constitute a part of a polygon. As long as the appearance has the configuration described above and is recognized as a prismatic form, a part of a long side may be partially curved.

The alumina particle 10 may have an aspect ratio of not less than 1.5, or an aspect ratio of or not less than 2. In this case, the aspect ratio of the alumina particle 10 is preferably not more than 3 because densification of the composite ceramic 1 can be achieved.

The aspect ratio of the alumina particle 10 is determined based on an image (photograph) taken by observing a cross section of the composite ceramic 1 by using an SEM. At this time, identification of whether the particle appeared in the photographed region is the alumina particle 10 or the zirconia particle 12 is performed by energy-dispersive X-ray spectroscopy (EDS).

Specifically, first, a photograph of approximately from 10 to 20 of the alumina particles 10 identified by the EDS analysis is selected. Then, a length L1 of a longest major axis of each alumina particle 10 present in the selected photograph is measured. Then, for the alumina particle 10 having the L1 measured, a length L2 in a right-angle direction at the center position of the L1 is measured. Then, a ratio of the L1 to the L2 (L1/L2) is determined. The L1/L2 is the aspect ratio.

When the aspect ratio of the alumina particle 10 is large, that is, when the alumina particle 10 has a long and narrow shape, a composite ceramic 1 having higher deformability is readily obtained because the spherical zirconia particle 12 is more likely to be arranged onto a side face of the alumina particle 10.

Note that an average particle size of the alumina particles 10 including the prismatic alumina particles 10 may be not less than 0.5 μm and not more than 3 μm. In this case, the average particle size of the alumina particles 10 is an average value of the length L1 and the length L2 used for calculation of the aspect ratio ((L1+L2)/2). The average particle size of the alumina particles 10 is determined by measuring all of the alumina particles 10 included in the photograph of approximately from 10 to 20 of the alumina particles 10.

An area percentage of the prismatic alumina particles 10 contained in the plurality of alumina particles 10 per unit area may be not less than 5% and not more than 10%.

The plurality of zirconia particles 12 includes spherical particles. Note that the “spherical” refers to that, when a cross section of the composite ceramic 1 is observed by using an SEM, a curved portion with respect to the entire contour of the zirconia particle 12 is not less than 80%.

Note that, in addition to the above-mentioned condition that the spherical zirconia particle 12 has the curved portion of not less than 80%, the spherical zirconia particle 12 preferably has an aspect ratio of not more than 1.1. In this case, in addition to the condition in which a surface of the alumina particle 10 and a surface of the zirconia particle 12 are partially in contact with each other, the composite ceramic 1 preferably includes a part in which surfaces of the plurality of zirconia particles 12 are partially in contact with each other. In other words, the plurality of zirconia particles 12 preferably includes zirconia particles having a second contact part 12B in which surfaces of the zirconia particles 12 are partially in contact with each other.

Also for the second contact part 12B, when a length of a contour of a spherical zirconia particle 12 positioned on one side is 100, a range of contact of the spherical zirconia particles 12 is not less than 1 and not more than 20 and, particularly, may be not less than 1 and not more than 10, of the length of the contour.

Note that the zirconia particle 12 having a surface partially in contact with a surface the prismatic alumina particle 10 may be only spherical zirconia particles 12 or may also be pseudospherical zirconia particles 12 described below. Alternatively, both of the spherical zirconia particle 12 and the pseudospherical zirconia particle 12 may be partially in contact with the prismatic alumina particle 10 at their surfaces.

Because the zirconia particle 12 naturally has a lower modulus of elasticity than that of the alumina particle 10, the composite ceramic 1 more readily deforms when the composite ceramic 1 includes a part in which the plurality of zirconia particles 12 is in contact with each other in a small area. In this case, the composite ceramic 1 includes three alumina particles 10 that are present in contact with each other, and any of the three alumina particles 10 is in contact with one or more of the spherical zirconia particles 12. In this case, one or more prismatic alumina particles 10 are preferably included among the three alumina particles 10.

When a surface of the prismatic alumina particle 10 is classified into an end face f1 and a side face f2 in the composite ceramic 1, preferably a larger number of first contact parts 12A are present on the side face f2 than on the end face f1. Note that the end face f1 of the prismatic alumina particle 10 is a part corresponding to a short side when a cross section of the alumina particle 10 is observed. On the other hand, the side face f2 of the prismatic alumina particle 10 is a part corresponding to a long side when a cross section of the alumina particle 10 is observed. One or more spherical zirconia particles 12 are present in a unit area including three of the alumina particles 10 including the prismatic alumina particle 10.

In other words, the plurality of zirconia particles 12 may have a part that is in point contact with a surface of the alumina particle 10. “Being in point contact” refers to a condition of being in contact with another particle at a length that is not more than 20%, not more than 10%, or particularly not more than 5%, of the length of the contour of the zirconia particle 12.

The average particle size of the zirconia particles 12 including the spherical and pseudospherical zirconia particles 12 is preferably not less than 0.7 μm and not more than 1 μm. In this case, similarly to the case of the alumina particles 10, the average particle size of the zirconia particles 12 is also a value calculated as an average value of the length L1 and the length L2 used for calculation of the aspect ratio ((L1+L2)/2). The average particle size of the zirconia particles 12 is determined by measuring all of the zirconia particles 12 included in the photograph of approximately from 10 to 20 of the alumina particles 10.

The Si composite oxide phase 14 is a grain boundary phase containing the alumina particles 10 and the zirconia particles 12. The Si composite oxide phase 14 may contain a little amount of crystal phase. As long as the Si composite oxide phase 14 can make various properties, such as deflection amount, fracture toughness, and three-point bending strength, of the composite ceramic 1 to not less than predetermined values, the Si composite oxide phase 14 is preferably contained in a proportion that allows even distribution of the Si composite oxide phase 14 around the alumina particles 10 and the zirconia particles 12. In this case, the proportion of the Si composite oxide phase 14 is preferably not less than 1% and not more than 7% in terms of an area percentage.

The alumina particle 10, the zirconia particle 12, and the Si composite oxide phase 14 have Young's moduli that are different from each other. Specifically, the Young's moduli increase in the order of the Si composite oxide phase 14<the zirconia particle 12<the alumina particle 10. As described above, in the composite ceramic 1 according to the embodiment, the zirconia particles 12 have a small contact area with respect to the alumina particles 10 having a high Young's modulus, and the Si composite oxide phase 14 having a lower Young's modulus than these is present around the alumina particles 10 and the zirconia particles 12. This provides a composite ceramic 1 having a large deflection amount and high deformability. Note that the “high deformability” refers to exhibiting deflection amount of not less than 0.5 mm with respect to a span of 10 mm when three-point bending strength test is performed for a test piece having a width of 10 mm and a thickness of 0.05 mm. Specifically, this composite ceramic 1 preferably has a deflection amount of not less than 0.7 mm.

Note that the composite ceramic 1 may have a fracture toughness of not less than 3.5 MPa·√m, and particularly not less than 3.8 MPa·√m. The composite ceramic 1 may have a three-point bending strength of not less than 750 MPa, and particularly not less than 800 MPa. This provides a composite ceramic 1 having high strength. This composite ceramic 1 has deformability with a deflection amount of not less than 0.7 mm while having the fracture toughness of not less than 3.5 MPa·√m and the three-point bending strength of not less than 750 MPa.

In this case, the mass proportion of the alumina particles 10 contained in the composite ceramic 1 is preferably not less than 60% and not more than 85%.

The mass proportion of the zirconia particles 12 contained in the composite ceramic 1 is preferably not less than 20% and not more than 40%.

The mass proportion of the Si composite oxide phase 14 contained in the composite ceramic 1 is preferably not less than 2.4% and not more than 4.8%.

When the content proportions of the alumina particles 10, the zirconia particles 12, and the Si composite oxide phase 14 contained in the composite ceramic 1 are converted to volume basis, the volume fraction of the alumina particles 10 is not less than 70% and not more than 75%, the volume fraction of the zirconia particles 12 is not less than 18% and not more than 23%, and the volume fraction of the Si composite oxide phase 14 is not less than 4% and not more than 11%. In this case, the density of the alumina particle 10 is 4 g/cm³, the density of the zirconia particle 12 is 6 g/cm³, and the density of the Si composite oxide phase 14 is 2 g/cm³.

In addition to the alumina particles 10 that are a first phase and the zirconia particles 12 that are a second phase, the composite ceramic 1 contains a proportion in terms of volume of not less than 4% and not more than 11% of a third phase containing the Si composite oxide phase 14, and thus the composite ceramic 1 has a property that is flexible while having high strength.

The area percentages of the alumina particles 10, the zirconia particles 12, and the Si composite oxide phase 14 constituting the composite ceramic 1 are as follows.

The area percentage per unit area of each of the alumina particles 10 and the zirconia particles 12 contained in the composite ceramic 1 are not less than 40% and not more than 60% for the alumina particles 10 and not less than 30% and not more than 40% for the zirconia particles 12. The Si composite oxide phase 14 that is the rest is preferably not less than 5% and not more than 20%.

Note that the Si composite oxide phase 14 preferably contains an alkaline-earth element (Mg, Ca) in addition to Si. In this case, the Si and the alkaline-earth element are contained as oxides.

The proportions of the alumina particles 10, the zirconia particles 12, and the Si composite oxide phase 14 contained in the composite ceramic 1 can be determined, for example, by inductively coupled plasma (ICP) analysis. Among a plurality of elements confirmed by the ICP analysis, aluminum (Al) is calculated as Al₂O₃ and used as a proportion of the alumina particles 10.

In the same or similar manner, among a plurality of elements confirmed by the ICP analysis, zirconium (Zr) is calculated as ZrO₂ and used as a proportion of the zirconia particles 12.

When the rest of elements are, for example, Si, Mg, and Ca, the Si, the Mg, and the Ca are respectively calculated as SiO₂, MgO, and CaO. The total amount of these three components is the rest of the content of the composite ceramic 1.

Then, the total amount of the proportions of the alumina particles 10, the zirconia particles 12, and the rest is defined as the entire amount of the composite ceramic 1 (100 mass %).

Then, the portion determined by subtracting the contents of the alumina particles 10 and the zirconia particles 12 from the entire amount is defined as the content of the rest, and the content of the rest is determined to be the content of the Si composite oxide phase 14.

The component contained in the Si composite oxide phase 14 can be detected by an analyzer attached to an electron microscope (energy-dispersive X-ray spectroscope: EDS). Whether the Si composite oxide phase 14 is amorphous (glass) can be determined by electron diffraction attached to an electron microscope.

A relative dielectric constant of the composite ceramic 1 may be lower than that of zirconia. Specifically, the relative dielectric constant of the composite ceramic 1 may be not less than 9 and not more than 15. Because the relative dielectric constant of the composite ceramic 1 is lower than that of zirconia, for example, electrical characteristics of an element to be mounted is less likely to deteriorate when the composite ceramic 1 is used as a substrate to which the element is mounted.

As described above, the plurality of zirconia particles 12 includes spherical particles; however, in this case, the spherical is not limited to a shape close to a perfect circle.

The spherical refers to a shape having a D2/D1 ratio of not less than 0.8 and not more than 1 when a longest major axis D1 of a cross section of a zirconia particle 12 and a length D2 in a right-angle direction with respect to a direction along the longest major axis are measured. In this case, for example, a zirconia particle 12 having a cross section with a shape that is close to a hexagon or octagon may be included. In other words, a particle having a pseudospherical shape may be included. Note that the “particle having a pseudospherical shape” refers to that, when a cross section of the composite ceramic 1 is observed by using an SEM, the aspect ratio is more than 1.1 and not more than 1.2, and a curved portion with respect to the entire contour of the zirconia particle 12 is not less than 50% and not more than 70%.

Note that a pseudospherical shape may be referred to as pseudospherical. The composite ceramic 1 may include pseudospherical zirconia particles 12 together with the spherical zirconia particles 12.

The plurality of zirconia particles 12 may include a part in which surfaces of the plurality of zirconia particles 12 are partially in contact with each other. The part in which surfaces of the plurality of zirconia particles 12 are partially in contact with each other may be referred to as a second contact part. In other words, a part in which a plurality of zirconia particles 12 is in point contact with each other may be included.

### EXAMPLES

Sample Nos. 1 to 6 were prepared, and the properties thereof were evaluated.

Alumina powder, zirconia powder, and glass powder were mixed in predetermined proportions and fired in a predetermined firing condition (temperature), and thus each sintered body was obtained. The proportions of the alumina particle powder, the zirconia powder, and the glass powder in the samples Nos. 1 to 6 and firing temperatures are listed in Table 1.

As the Si composite oxide powder, a mixed powder of SiO₂, CaO (raw material was CaCO₃), and MgO (talc) was used. The proportions of the SiO₂, the CaO (raw material was CaCO₃), and the MgO (talc) in the mixed powder were 3:1:1 in terms of mass ratio.

This mixed powder had a larger average particle size than the average particle size of the alumina powder. The average particle size of the mixed powder was 1.3 times the average particle size of the alumina powder when the average particle size of the alumina powder was defined as 1. The average particle size of the CaCO₃ was twice the average particle size of the SiO₂. The average particle size of the MgO was four times the average particle size of the SiO₂. The average particle size of the zirconia powder was 0.17 times the average particle size of the alumina powder when the average particle size of the alumina powder was defined as 1.

Specifically, the used raw material powders had the average particle sizes listed below. The average particle size of the alumina powder was 1.4 μm. The average particle size of the zirconia powder was 0.24 μm. The average particle size of the SiO₂ powder was 1.06 μm. The average particle size of the CaO (CaCO₃) was 2.0 μm. The average particle size of the MgO (talc) was 4.16 μm.

Note that all the prepared samples after firing each had a composition identical to a formulation composition as a result of compositional analysis. The compositional analysis used atomic absorption spectrometry and ICP analysis. All the prepared samples after firing each had a porosity of not more than 2% and were closely packed bodies.

TABLE 1

| | | | Mixed | |
|---|---|---|---|---|
| | Alumina | Zirconia | powder | Firing |
| Sample | powder | powder | (parts by | temperature |
| No. | (mass %) | (mass %) | mass) | (°C) |
| 1 | 70 | 30 | 3.6 | 1550 |
| 2 | 70 | 30 | 2.4 | 1550 |
| 3 | 70 | 30 | 4.8 | 1550 |
| 4 | 80 | 20 | 3.6 | 1550 |
| 5 | 60 | 40 | 3.6 | 1550 |
| 6 | 70 | 30 | 1.0 | 1400 (Normal |
| | | | | pressure) + |
| | | | | 1350 (HIP) |

Table 2 lists the results of observing cross sections of the sintered bodies of the samples Nos. 1 to 6. The samples Nos. 1 to 6 were each prepared in the conditions listed in Table 1.

First, identification of the prepared sample as a composite ceramic 1 was performed by the following method. A rectangular region including 10 to 20 alumina particles 10 was identified, and main components of the particles present in this region were identified by using an EDS, and the alumina particles 10 and the zirconia particles 12 were distinguished.

Then, a length L1 of a longest major axis and a length L2 in a right-angle direction to the length L1 of each alumina particle 10 present in the selected photograph was measured. Thus, the aspect ratio and the average particle size were determined. The aspect ratio was determined based on the ratio L1/L2. The average particle size was determined by (L1+L2)/2.

The sintered body of the composite ceramic 1 of each of the samples Nos. 1 to 6 contained the prismatic alumina particles 10, as a result of observation using an SEM. The sintered body of the composite ceramic 1 of each of the samples Nos. 1 to 6 contained the alumina particles 10 each having an aspect ratio of not less than 1.5.

The following evaluations were performed for the zirconia particles 12. The evaluations included the shape of zirconia particles 12, the proportion of the number of a plurality of zirconia particles 12 that were spherical particles, the proportion of curved portion of the zirconia particles 12 that had been identified as spherical particles (proportion of length of contour), the aspect ratio, the average particle size, and the proportion of the number of areas satisfying the condition of the first contact part.

The evaluations of the aspect ratio and the average particle size used the same and/or similar methods for the case of the alumina particles 10. The proportion of the number of spherical particles among the zirconia particles 12 was determined by dividing the number of zirconia particles 12 judged as spherical by the total number of all the zirconia particles 12 present in the region.

Note that the zirconia particles 12 being spherical were those having an aspect ratio of not more than 1.1 and having a proportion of a length of a curved portion in the contour of zirconia particle 12 of not less than 80%, among all the zirconia particles 12 for which the aspect ratios were measured. The zirconia particles 12 being pseudospherical were those having an aspect ratio of more than 1.1 and not more than 1.2 and having a proportion of a length of a curved portion in the contour of zirconia particle 12 of not less than 50% and not more than 70%, among all the zirconia particles 12 for which the aspect ratios were measured.

The sintered body of the composite ceramic 1 of each of the prepared samples Nos. 1 to 5 contained spherical particles and pseudospherical particles as listed in Table 2.

The proportion of the number of areas satisfying the condition of the first contact part 12A was determined by counting visually in the photograph evaluated as described above. Note that, among the prepared samples, the sintered body of the composite ceramic 1 of each of the samples Nos. 1 to 5 also included the second contact part 12B in which surfaces of the plurality of zirconia particles 12 were partially in contact with each other.

The area percentage of the Si composite oxide phase 14 was determined by taking an area of the entire region of the photograph used in the evaluation above as A0 and taking a total area of areas of the alumina particles 10 and areas of the zirconia particles 12 as A1 for the alumina particles 10 and the zirconia particles 12, and calculating (A0-A1)/A0.

TABLE 2

| | | | Zirconia particles | | | | | | | |
|---|---|---|---|---|---|---|---|---|---|---|
| | | | | | | | | Proportion | | |
| | Alumina | | | | | | | of number | | Composite |
| | particles | | | | | | | of zirconia | | oxide |
| | | Average | Proportion | | Proportion | | Average | particles | | phase |
| | | particle | of number | | of curved | | particle | constituting | | Area |
| Sample | Aspect | size | of spherical | | portion | Aspect | size | first | | percentage |
| No. | ratio | (μm) | particles | Shape | (%) | ratio | (μm) | contact part | | (%) |
| 1 | 1.8 | 1.8 | 9/29 | Spherical + | 55 | 1.4 | 0.9 | 7/29 | (24%) | 3.1 |
| | | | | pseudospherical | | | | | | |
| 2 | 1.5 | 1.8 | 1/41 | Spherical + | 14 | 1.5 | 0.8 | 1/41 | (2.4%) | 1.1 |
| | | | | pseudospherical | | | | | | |
| 3 | 1.7 | 1.8 | 9/30 | Spherical + | 65 | 1.3 | 1.0 | 9/30 | (30%) | 6.6 |
| | | | | pseudospherical | | | | | | |
| 4 | 2.2 | 1.9 | 2/16 | Spherical + | 17 | 1.5 | 1.0 | 1/16 | (6.3%) | 3.7 |
| | | | | pseudospherical | | | | | | |
| 5 | 1.8 | 1.7 | 1/45 | Spherical + | 22 | 1.4 | 0.8 | 4/45 | (16%) | 2.7 |
| | | | | pseudospherical | | | | | | |
| 6 | 2.4 | 0.8 | 0/10 | Polygon | 5 | 1.2 | 0.4 | 0 | (0%) | 1.0 |

Table 3 shows results of applicability evaluation performed by measuring properties of the samples Nos. 1 to 6. The deflection test to measure the deflection amount was performed simultaneously with the three-point bending strength test. Specifically, a measurement sample was cut out from the prepared sample, the deflection amount was determined to be an amount of displacement from a flat state when the measurement sample was broken at the time of performing the three-point bending strength test. The approximate size of the measurement sample was 20 mm in length, 4 mm in width, and 50 μm in thickness.

The fracture toughness of each of the samples was measured in accordance with the indentation fracture method (IF method) stipulated in JIS R 1607-1995. In this case, in addition to the measurement sample described above, a sample having a thickness of 2 mm was separately prepared.

In Table 3, three-grade evaluation was performed. A sample having particularly good applicability was evaluated as “Excellent”. A sample having good applicability was evaluated as “Good”. A sample that was unapplicable was evaluated as “Poor”. Note that, in the three-grade evaluation described above, “Excellent” and “Good” are considered to satisfy the criteria for the composite ceramic 1.

TABLE 3

| | | | Three-point | |
|---|---|---|---|---|
| | Deflection | Fracture | bending | |
| Sample | amount | toughness | strength | |
| No. | (mm) | (MPa · √m) | (MPa) | Applicability |
| 1 | 0.81 | 4.5 | 901 | Excellent |
| 2 | 0.84 | 3.8 | 988 | Excellent |
| 3 | 0.75 | 4.8 | 788 | Good |
| 4 | 0.71 | 4.2 | 822 | Good |
| 5 | 0.82 | 4.6 | 758 | Excellent |
| 6 | 0.48 | 5.0 | 1350 | Poor |

The samples Nos. 1 to 5 each had a deflection amount of not less than 0.5 mm. Thus, the composite ceramics 1 having high deformability were obtained. On the other hand, although the sample No. 6 had higher fracture toughness and three-point bending strength than those of the samples Nos. 1 to 5, the sample No. 6 had the deflection amount of less than 0.5 mm and was found to be a composite ceramic 1 having poor deformability.

The sample No. 6 did not contain spherical and pseudospherical zirconia particles 12 as the zirconia particles 12.

For each of the samples Nos. 1 to 3 and 5, the area percentage of the alumina particles 10 was not less than 60% and not more than 70%, and the area percentage of the zirconia particles 12 was not less than 30% and the not more than 40%.

For each of the samples Nos. 1, 3, and 5, the proportion of the number of the zirconia particles 12 constituting the first contact part 12A was not less than 16%.

The sintered body of the composite ceramic of each of the samples Nos. 1 to 5 included a part where one or more spherical zirconia particles 12 were in contact with any of the three alumina particles 10 present in contact with each other.

The sintered body of the composite ceramic of each of the samples Nos. 1 to 5 was in a condition having a larger number of the first contact parts present on the end face than on the side face when a surface of the prismatic alumina particle 10 was classified into an end face and a side face.

FIG. 2 is a graph showing a relationship between aspect ratio and frequency of alumina particles contained in a composite ceramic. FIG. 2 shows the case of the sample No. 1 as an example of the composite ceramic.

The composite ceramic of the present disclosure includes two groups having different aspect ratios when the aspect ratio is on the horizontal axis and the frequency (number of particles) is on the vertical axis for the alumina particles. As shown in FIG. 2, the alumina particles have groups of two peaks of different aspect ratios.

In this case, identification of the prepared sample as a composite ceramic was performed by the following method. A rectangular region including 70 to 100 alumina particles was identified, and the main component of the particles present in this region was identified by using an analyzer (EDS) attached to an electron microscope, and the alumina particles were identified.

Then, from the electron micrograph, the length L of the major axis of the alumina particle and the length S of the minor axis intersecting the major axis in a right-angle direction to the major axis were determined, and the ratio thereof (L/S) was determined and used as the aspect ratio of the alumina particles.

In this case, the graph was plotted with aspect ratio intervals of 0.1. The graph shows a first group having an aspect ratio range of not less than 1.3 and not more than 2.2 and a second group having an aspect ratio range of not less than 2.6 and not more than 2.8. In this evaluation, the groups having different aspect ratios exist when the aspect ratio is not less than 0.2.

For this reason, in the graph, even when the frequency of the aspect ratio range of more than 1.6 and not more than 1.7 is 0, the range of the aspect ratio of not more than 1.5 and the range of not less than 1.7 are not considered to be different groups of the aspect ratios.

In addition to the sample No. 1, also when the relationship between the aspect ratio and the frequency thereof was evaluated for the sample No. 2 and the sample No. 5, two different groups existed similarly to those shown in FIG. 2.

The samples No. 1, No. 2, and No. 5 each had a deflection amount of not less than 0.81 mm.

The reason why the graph showing the relationship between the aspect ratio and the frequency thereof of the alumina particles had the two groups having different aspect ratios is due to use of the mixed powder having an average particle size larger than the average particle size of the alumina powder and due to adjustment of the composition of the alumina powder, the zirconia powder, and the mixed powder that became the Si composite oxide as listed in Table 1.

In an embodiment, (1) a composite ceramic includes:
a plurality of alumina particles; a plurality of zirconia particles; and a Si composite oxide phase, wherein
the plurality of alumina particles includes a prismatic particle,
the plurality of zirconia particles includes a spherical particle, and
the prismatic particle includes prismatic particles, and the spherical particle includes spherical particles, the prismatic particles and the spherical particles having first contact parts in each of which a surface of the prismatic particle and a surface of the spherical particle are partially in contact with each other.
(2) In the composite ceramic according to (1) above, the plurality of zirconia particles may include zirconia particles having a second contact part in which surfaces of the zirconia particles are partially in contact with each other.
(3) In the composite ceramic according to (1) or (2) above, each of the alumina particles may have an aspect ratio of not less than 1.5.
(4) In the composite ceramic according to any one of (1) to (3) above, any of three of the alumina particles that are present in contact with each other may be in contact with one or more of the spherical particles.
(5) In the composite ceramic according to any one of (1) to (4) above, when a surface of the prismatic particle is classified into an end face and a side face, a larger number of the first contact parts may be present on the side face than on the end face.
(6) In the composite ceramic according to any one of (1) to (5) above,
   the Si composite oxide phase may be present in a region other than a region of the alumina particles and the zirconia particles, and
   the Si composite oxide phase may be present in an area percentage of not less than 1% and not more than 7% per unit area.
(7) In the composite ceramic according to any one of (1) to (6) above, the alumina particles may include two groups having different aspect ratios.
(8) In the composite ceramic according to any one of (1) to (7) above, the composite ceramic may include not less than 60 mass % and not more than 85 mass % of the alumina particles, not less than 20 mass % and not more than 40 mass % of the zirconia particles, and not less than 2.4 mass % and not more than 4.8 mass % of the Si composite oxide phase.
(9) In the composite ceramic according to any one of (1) to (8) above, a volume fraction of the alumina particles may be not less than 70% and not more than 75%, a volume fraction of the zirconia particles may be not less than 18% and not more than 23%, and a volume fraction of the Si composite oxide phase may be not less than 4% and not more than 11%.

Additional effects and other aspects can be easily derived by a person skilled in the art. Thus, a wide variety of aspects of the present disclosure are not limited to the specific details and representative embodiments represented and described above. Accordingly, various changes are possible without departing from the spirit or scope of the general inventive concepts defined by the appended claims and their equivalents.

### REFERENCE SIGNS

1 Composite ceramic
10 Alumina particle
12 Zirconia particle
12A First contact part
12B Second contact part
14 Si composite oxide phase

1. A composite ceramic comprising:
a plurality of alumina particles; a plurality of zirconia particles; and a Si composite oxide phase, wherein
the plurality of alumina particles comprises a prismatic particle,
the plurality of zirconia particles comprises a spherical particle, and
the prismatic particle comprises prismatic particles, and the spherical particle comprises spherical particles, the prismatic particles and the spherical particles having first contact parts in each of which a surface of the prismatic particle and a surface of the spherical particle are partially in contact with each other.

2. The composite ceramic according to claim 1, wherein
the plurality of zirconia particles comprises zirconia particles having a second contact part in which surfaces of the zirconia particles are partially in contact with each other.

3. The composite ceramic according to claim 1, wherein each of the alumina particles has an aspect ratio of not less than 1.5.

4. The composite ceramic according to claim 1, wherein
any of three of the alumina particles that are present in contact with each other is in contact with one or more of the spherical particles.

5. The composite ceramic according to claim 1, wherein
when a surface of the prismatic particle is classified into an end face and a side face, a larger number of the first contact parts are present on the side face than on the end face.

6. The composite ceramic according to claim 1, wherein
the Si composite oxide phase is present in a region other than a region of the alumina particles and the zirconia particles, and
the Si composite oxide phase is present in an area percentage of not less than 1% and not more than 7% per unit area.

7. The composite ceramic according to claim 1, wherein
the alumina particles comprise two groups having different aspect ratios.

8. The composite ceramic according to claim 1, wherein the composite ceramic comprises not less than 60 mass % and not more than 85 mass % of the alumina particles, not less than 20 mass % and not more than 40 mass % of the zirconia particles, and not less than 2.4 mass % and not more than 4.8 mass % of the Si composite oxide phase.

9. The composite ceramic according to claim 1, wherein a volume fraction of the alumina particles is not less than 70% and not more than 75%, a volume fraction of the zirconia particles is not less than 18% and not more than 23%, and a volume fraction of the Si composite oxide phase is not less than 4% and not more than 11%.
